(19) United States
(12) Patent Application Publication
(10) Pub. No.: US 2025/0360892 A1
(43) Pub. Date: Nov. 27, 2025

(54) WIPER SKELETON ASSEMBLY

(71) Applicant: DANYANG UPC AUTO PARTS CO., LTD., DANYANG (CN)

(72) Inventors: Che-Wei CHANG, DANYANG (CN); Cheng-Kai YANG, DANYANG (CN); Chuan-Chih CHANG, DANYANG (CN)

(21) Appl. No.: 18/675,027

(22) Filed: May 27, 2024

(51) Int. Cl. B60S 1/38

(52) U.S. Cl. CPC B60S 1/38

(57) ABSTRACT

A wiper skeleton assembly includes a medium frame, a main frame, two wing strips, and two fasteners. The medium frame has two first though slots and pivoted on the main frame. The wing strips are corresponding to the first though slots and respectively has a second through slot and a stopping block. The fasteners are corresponding to the wing strips and respectively has a main body, an upper cover, and a blocking portion. The upper cover and the blocking portion are connected to two ends of the main body. When the wiper skeleton assembly is locked, the main bodies penetrate the first and second through slots, the blocking portions and the upper covers are abutted to opposite sides of the wing strips and the medium frame, the stopping blocks are configured to block the blocking portions to prevent the fasteners loosened from the medium frame and the wing strip.

### BACKGROUND

### Technical Field

The present disclosure relates to wiper, particularly to a skeleton assembly of a skeleton wiper.

### Description of Related Art

Common wiper types are mainly divided into two types: skeleton wiper and flat wiper. Skeleton wiper is not only cheaper than flat wiper, but also has a better structural strength to make a wiper blade to snug fit a glass when operating such that skeleton wiper can achieve a good effect of wiping rain and dust. The existing skeleton wiper mainly includes a main frame, two medium frames, and four wing strips. The main frame connects to the two medium frames, each of the medium frames connects to the two wing strips to clamp the wiper blade, so as to form a plurality of pressure points to ensure the wiper blade can snug fit an arc surface of the glass when operating.

However, for most of the existing skeleton wipers, a connection between the main frame and the medium frame or between the medium frame and the wing strip is connected by the way of pivoting via a shaft or buckling via a fastener. Although the main frame, the medium frames, and the wing strips are capable of forming a linkage, the connections are often loosened due to vibration, collision, or prolonged use, which in turn affects the durability and safety of the vehicle wipers.

In view of the above, the inventor seeks to overcome the aforementioned drawbacks associated with the current technology and aims to provide an effective solution through extensive researches along with utilization of academic principles and knowledge.

### SUMMARY

The primary objective of the present disclosure is to prevent the fastener loosened from the medium frame and the wing strips due to vibration or collision through stopping by the stopping block.

To accomplish the aforementioned objective, the present disclosure provides a wiper skeleton assembly having a medium frame, a main frame, a pair of wing strips, and a pair of fasteners, the medium frame has a pivot portion and defines a pair of first though slots, the pivot portion is located between the first though slots, the first though slots are respectively arranged on two ends of the medium frame, one end of the main frame is pivoted to the pivot portion, the wing strips are respectively configured to corresponding to each of the first though slots, each of the wing strips defines a second though slot and has a stopping block, the stopping block in each of the wing strips is arranged on a side of the wing strip away from the medium frame and adjacent to the second through slot, the fasteners are respectively configured to corresponding to each of the wing strips, each of the fasteners has a main body, an upper cover, and a blocking portion, the upper cover and the blocking portion are respectively connected to two ends of the main body in each of the fasteners, when the wiper skeleton assembly is locked, the main body of each of the fasteners penetrates the second through slot of the corresponded wing strip and the corresponded first through slot of the wing strip, the blocking portion and the upper cover in each of the fasteners respectively are abutted to opposite sides of the corresponded wing strip and the medium frame, each of the stopping blocks is configured to block a side of each of the blocking portions

Another aspect of the present disclosure provides that each of the fasteners further comprises a locking portion extended from the main body and located between the upper cover and the blocking portion, each of the locking portions is accommodated in each of the corresponded first through slots when the wiper skeleton assembly is locked.

Another aspect of the present disclosure provides that in each of the fasteners, the locking portion and the blocking portion are arranged on the main body in an intersecting and staggered manner.

Another aspect of the present disclosure provides that in each of the fasteners, a shape of the locking portion is corresponding to a shape of the first through slot.

Another aspect of the present disclosure provides that in each of the wing strips, a number of the stopping block is two, the stopping blocks are respectively arranged on two opposite sides of the second through slot and located on a same side with the corresponded blocking portion.

Another aspect of the present disclosure provides that in each of the wing strips, a number of the stopping block is two, the stopping blocks are arranged on a same side of the second through slot and located two opposite sides of the corresponded blocking portion.

Another aspect of the present disclosure provides that in each of the wing strips, a number of the stopping block is four, two of the stopping blocks are respectively arranged on two opposite sides of the second through slot, the other two stopping blocks are respectively located on two opposite sides of the corresponded blocking portion.

Another aspect of the present disclosure provides that a shape of the blocking portion is corresponding to a shape of the first through slot and the second through slot.

Another aspect of the present disclosure provides that further has a pivot shaft, the main frame defines a pair of through holes, the pivot portion defines a pair of pivot holes, the pivot shaft penetrates the through holes and the pivot holes such that the main frame is pivoted on the pivot portion.

Another aspect of the present disclosure provides that a number of the medium frame is two, a number of the wing strip is two pairs, a number of the fastener is two pairs, two ends of the main frame is pivoting to the pivot portions, the medium frames, the wing strips, and the fasteners are symmetrically arranged on the two ends of the main frame.

Through arranging the stopping blocks on the side of the wing strips away from the medium frame and adjacent to the second through slots, the stopping blocks can respectively block the sides of the blocking portions when the wiper skeleton assembly is locked, so that it can prevent the fasteners loosened from the medium frame and the wing strips due to vibration, collision, or prolonged use to ensure a structure of the wiper skeleton assembly to be stable.

### BRIEF DESCRIPTION OF THE DRAWINGS

FIG. 1 is a perspective appearance view of the present disclosure installed on a wiper;

FIG. 2 is a partially exploded view in first embodiment of the present disclosure;

FIG. 3 is an assembling schematic view in first embodiment of the present disclosure;

FIG. 4 is another assembling schematic view in first embodiment of the present disclosure;

FIG. 5 is still another assembling schematic view in first embodiment of the present disclosure;

FIG. 6 is still another assembling schematic view in first embodiment of the present disclosure;

FIG. 7 is a partially bottom view in first embodiment of the present disclosure;

FIG. 8 is a cross-sectional view along line 8-8 of FIG. 7;

FIG. 9 is a cross-sectional view along line 9-9 of FIG. 7;

FIG. 10 is a cross-sectional side view of using status in first embodiment of the present disclosure;

FIG. 11 is a partially bottom view in second embodiment of the present disclosure; and

FIG. 12 is a partially bottom view in third embodiment of the present disclosure.

### DETAILED DESCRIPTION

It is to be understood that the terms for indicating positions and the location relation, for example “front”, “rear”, “left”, “right”, “front end”, “rear end”, “distal end”, “longitudinal direction”, “lateral direction”, “vertical direction”, “top” and “bottom”, are based on the positions and the location relation disclosed in the drawings, and only used for disclosing the present disclosure and not used for indicating or implying the specified location of the device or the components or the specified structure and operation in certain location, thus the present disclosure is not intended to be limiting.

For example, the terms of “first”, “second”, “third”, “forth” and “fifth” are used for illustrating each unit, component, area, layer and/or part. The component, the unit, the area, the layer and/or the part are not limited by the terms. These terms are only used for separating the element, the assembly, the area, the layer, or the part. Unless being clearly indicated according to the whole specification, the terms for example “the first”, “the second”, “the third”, “the fourth” and “the fifth” are not used for implying the order or sequence.

The technical contents of the present disclosure will become apparent with the detailed description of embodiments and the accompanied drawings as follows. However, it shall be noted that the accompanied drawings are for illustrative purposes only such that they shall not be used to restrict the scope of the present disclosure.

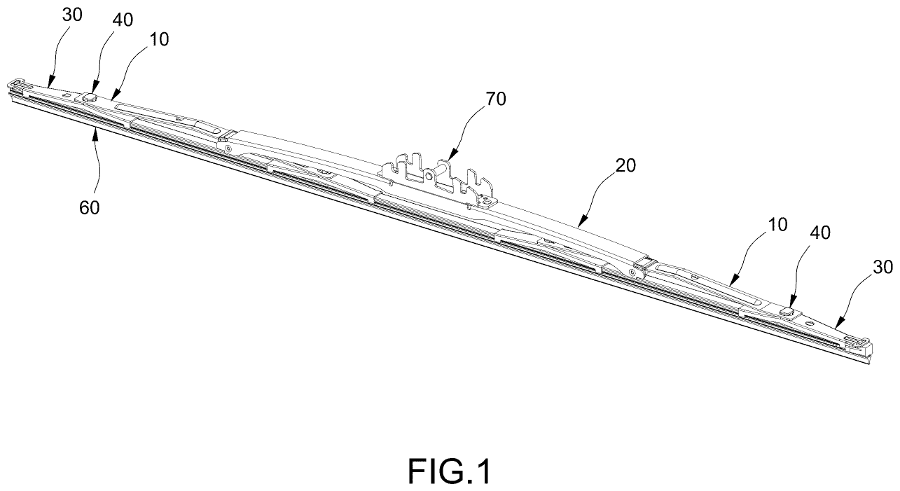

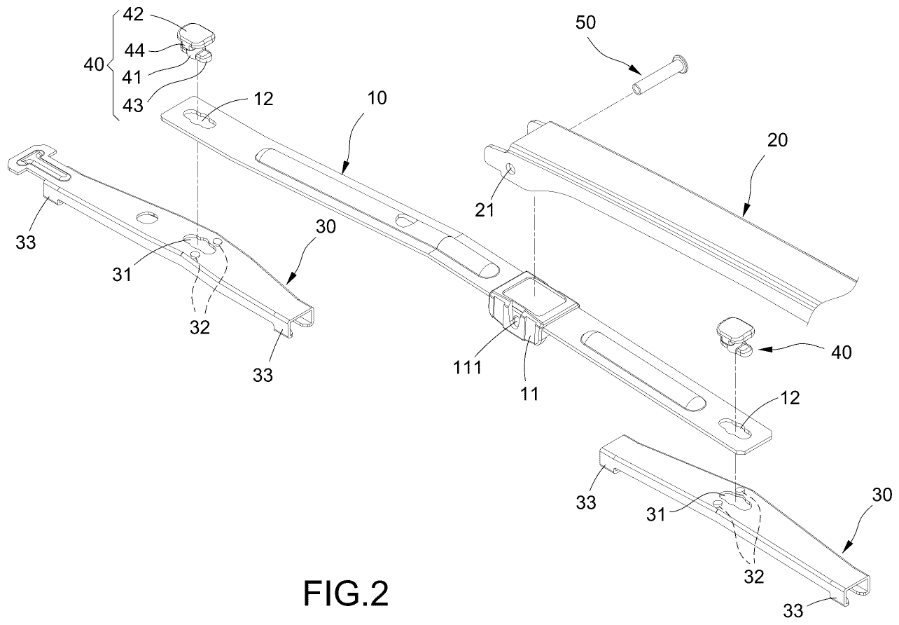

The present disclosure provides a wiper skeleton assembly used to install on a wiper. Please refer to FIG. 1 and FIG. 2, which show the first embodiment of the present disclosure. The wiper skeleton assembly of the present disclosure includes at least one medium frame 10, a main frame 20, at least a pair of wing strips 30, and at least a pair of fasteners 40. As shown in FIG. 1, in the first embodiment, a number of the medium frame 10 is two, a number of the wing strip 30 is two pairs, a number of the fastener 40 is two pairs, and the medium frames 10, the wing strips 30, and the fasteners 40 are symmetrically arranged on two ends of the main frame 20. For convenience of description, only one medium frame 10, one pair of wing strips 30, and one pair of fasteners 40 are used for description, yet this is not intended to limit the present disclosure.

Please refer FIG. 2. The medium frame 10 has a pivot portion 11 and defines a pair of first though slots 12. In detail, the first though slots 12 are respectively arranged on two ends of the medium frame 10, and the pivot portion 11 is located between the first though slots 12 to divide the medium frame 10 into two sections. In the first embodiment, the two sections of the medium frame 10 are unequal in length and bent at an angle, but the present disclosure is not limit to this embodiment, the length of the two sections of the medium frame 10 may also be adjusted according to needs. Thus, the wiper would not cause insufficient pressure or excessive pressure when in use. In addition to being capable of cleaning a rainwater on a windshield, the wiper would also not jump during a brushing process.

The main frame 20 extends along its longitudinal direction to form elongated strip shape, and a cross-section of the main frame 20 in its lateral direction is inverted U shape. One end of the main frame 20 is pivoted to the pivot portion 11. In detail, the wiper skeleton assembly of the present disclosure further includes at least one pivot shaft 50. One end of the main frame 20 defines a pair of through holes 21, the pivot portion 11 defines a pair of pivot holes 111. The end of the main frame 20 is sleeved on the pivot portion 11 so that the through holes 21 are respectively located outside of the pivot holes 111. The pivot shaft 50 penetrates the through holes 21 and the pivot holes 111 such that the end of the main frame 20 is pivoted on the pivot portion 111. In the first embodiment, a number of the pivot shaft 50 is two, and two ends of the main frame 20 respectively defines a pair of through holes 21 for each of the pivot shafts 50 pivoting on each of the pivot portions 11 of each of the medium frames 10.

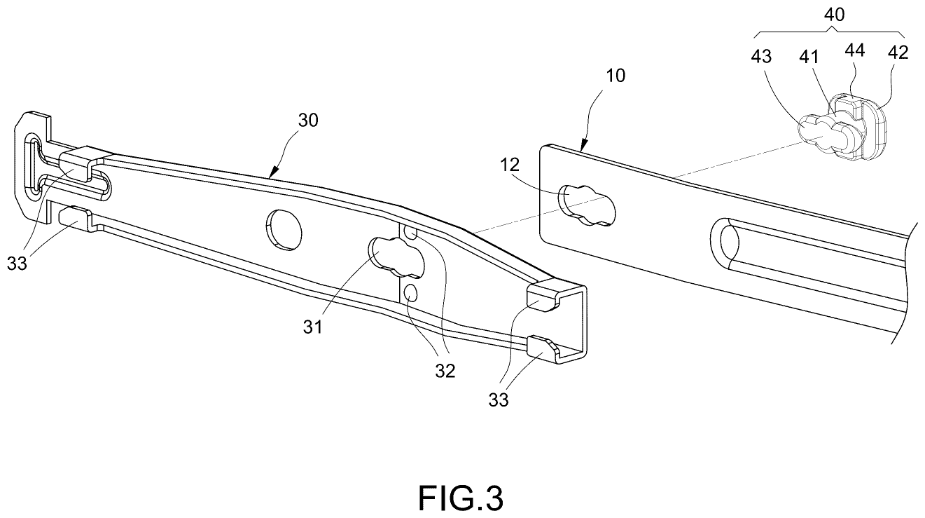

The pair of wing strips 30 are respectively configured to corresponding to each of the first though slots 12. Each of the wing strips 30 defines a second though slot 31 and has a stopping block 32. In the first embodiment, the stopping block 32 is a hemispherical bump, but the present disclosure is not limit to this shape. Please refer FIG. 2 and FIG. 3. The stopping block 32 in each of the wing strips 30 is arranged on a side of the wing strip 30 away from the medium frame 10 and adjacent to the second through slot 31 of the wing strip 30, that is each of the stopping blocks 32 is arranged on a bottom surface of each of the wing strips 30, and a top surface of each of the wing strips 30 is corresponding to a bottom surface of the medium frame 10. In the first embodiment, in each of the wing strips 30, a number of the stopping block 32 is two, each of the stopping blocks 32 is arranged on two opposite of the second through slots 31 and located on a same side with the corresponded blocking portion 43 described later, but the present disclosure is not limit to this embodiment. For example, arranging only one stopping block 32 in each of the wing strips 30 may also achieve an effect of stopping.

The pair of fasteners 40 are respectively configured to corresponding to each of the pair of the wing strips 30. Each of the fasteners 40 has a main body 41, an upper cover 42, and a blocking portion 43. In each of the fasteners 40, the upper cover 42 and the blocking portion 43 are respectively connected to two ends of the main body 41. In detail, the upper cover 42 is connected to top of the main body 41, and the blocking portion 43 is connected to a bottom of the main body 41. A shape of the blocking portion 43 is corresponding to a shape of the first through slot 12 and the second through slot 31 to achieve an easier penetration the blocking portion 43 into the first through slot 12 and the second through slot 31, but the shape of the blocking portion 43 may also be different to the shape of the first through slot 12 and the second through slot 31 as long as the blocking portion 43 can pass through the first through slot 12 and the second through slot 31. In the first embodiment, the upper cover 42 is roughly squircle, the blocking portion 43 is roughly rectangular, but the shape of the upper cover 42 and the blocking portion 43 of the present disclosure are not limit to those shapes.

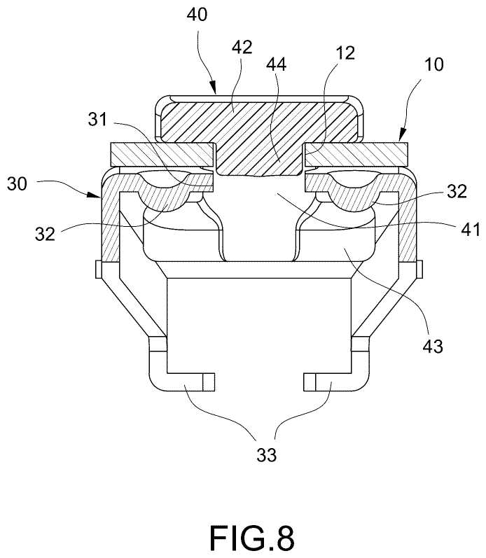

Please refer FIGS. 1, 7, 8, and 9. When the wiper skeleton assembly of the present disclosure is locked, the main body 41 of each of the fasteners 40 penetrates the second through slot 31 of the corresponded wing strip 30 and the corresponded first through slot 12 of the wing strip 30, the blocking portion 43 and the upper cover 42 in each of the fasteners 40 respectively are abutted to opposite sides of the corresponded wing strip 30 and the medium frame 10 (that is the top surface of the wing strip 30 and the bottom surface of the medium frame 10), each of the stopping blocks 32 is abutted to a side of each of the blocking portions 43, and each of the blocking portions 43 and the corresponded second through slot 31 are arranged in an intersecting and staggered manner. Therefore, since the stopping blocks 32 of each of the wing strips 30 are arranged on the two opposite of the second through slots 31 and located on the same side with the corresponded blocking portion 43, and each of the blocking portions 43 and the corresponded second through slot 31 are arranged in an intersecting and staggered manner, the stopping blocks 32 can prevent the blocking portion 43 from driving the fasteners 40 to rotate such that it can prevent the fasteners 40 loosened from the medium frame 10 and the wing strips 30 due to vibration, collision, or prolonged use to ensure a structure of the wiper skeleton assembly to be stable.

In addition, please refer FIGS. 2, 3, 4, and 5. Each of the fasteners 40 further includes a locking portion 44. In each of the fasteners 40, the locking portion 44 extends from the main body 41 and located between the upper cover 42 and the blocking portion 43, the locking portion 44 and the blocking portion 43 are arranged on the main body in an intersecting and staggered manner, and a shape of the locking portion 44 is corresponding to the shape of the first through slot 12. In the first embodiment, the locking portion 44 and the blocking portion 43 are perpendicular to each other and arranged staggered up and down, but the present disclosure is not limit to this embodiment as long as the locking portion 44 and the blocking portion 43 are intersecting. Therefore, each of the locking portions 44 is accommodated in each of the corresponded first through slots 12 when the wiper skeleton assembly is locked, so that each of the first through slots 12 restricts each of the locking portions 44 to prevent the fasteners 40 form rotating relative to the medium frame 10.

Please refer FIGS. 3, 4, 5, 6, and 7, which is the assembling process in the first embodiment of the wiper skeleton assembly of the present disclosure. Details are provided as follows.

First, after pivoting the main frame 20 on the pivot portion 11 of the medium frame 10, then the assembling process puts the top surface of the wing strip 30 to face the bottom surface of the medium frame 10 such that the second through slot 31 of the wing strip 30 is corresponding to the first through slot 12 of the medium frame 10, and then the assembling process aligns the blocking portion 43 of the fastener 40 with the first through slot 12 of the medium frame 10 and the second through slot 31 of the wing strip 30, as shown in FIG. 2 and FIG. 3.

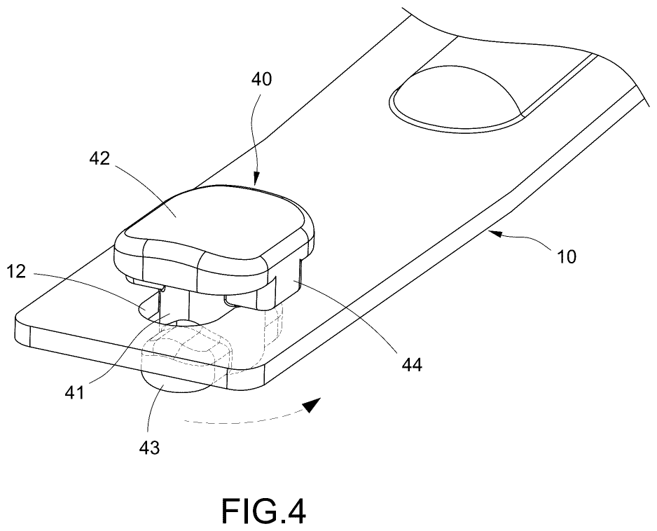

As shown in FIG. 4, the assembling process puts the blocking portion 43 of the fastener 40 to pass through the first through slot 12 of the medium frame 10 so that the main body 41 of the fastener 40 penetrates the first through slot 12. At this time, the locking portion 44 and the blocking portion 43 are intersecting, thus the locking portion 44 is abutted to a top surface of the medium frame 10 such that the fastener 40 cannot be inserted further downwards. Then, the assembling process rotates the fastener 40 relative to the medium frame 10 or rotate the medium frame 10 relative to the fastener 40, so that the locking portion 44 of the fastener 40 would be accommodated and embedded in the first through slots 12 of the medium frame 10.

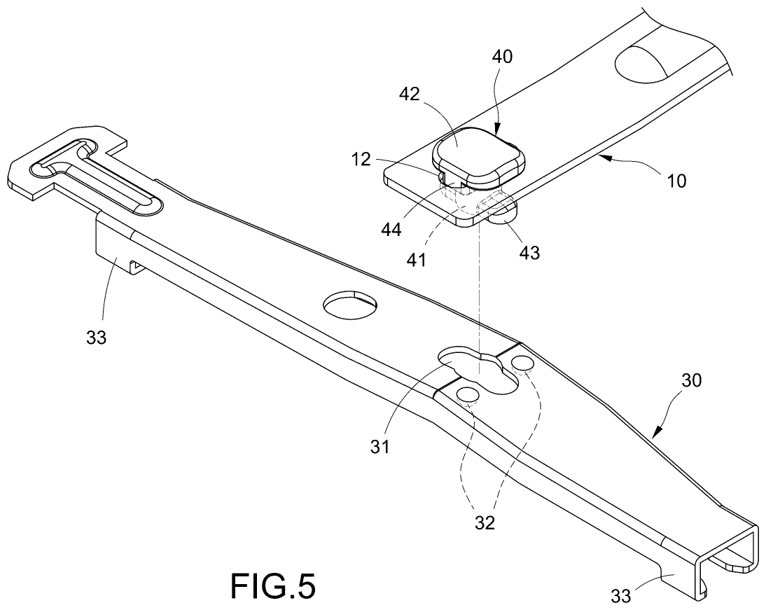

As shown in FIG. 5, after engaging the fastener 40 with the medium frame 10, the assembling process arranges the medium frame 10 and the wing strip 30 in the intersecting manner such that the bottom surface of the medium frame 10 is facing to the top surface of the wing strip 30, and then the assembling process aligns the blocking portion 43 of the fastener 40 with the second through slot 31 of the wing strip 30.

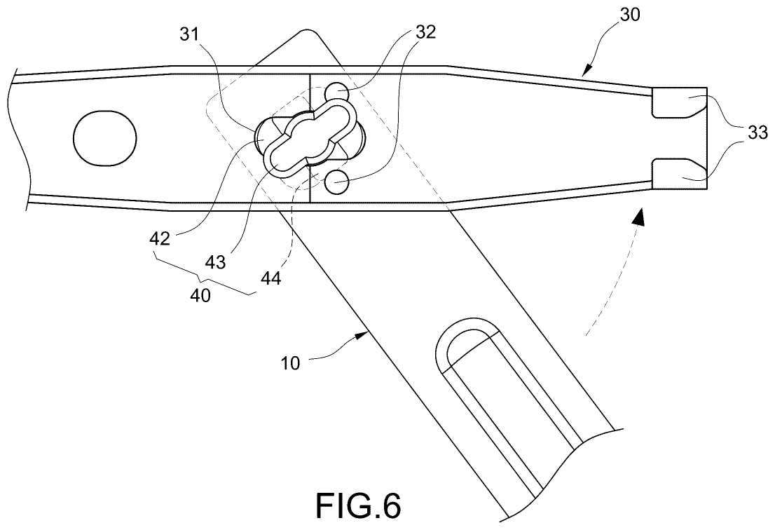

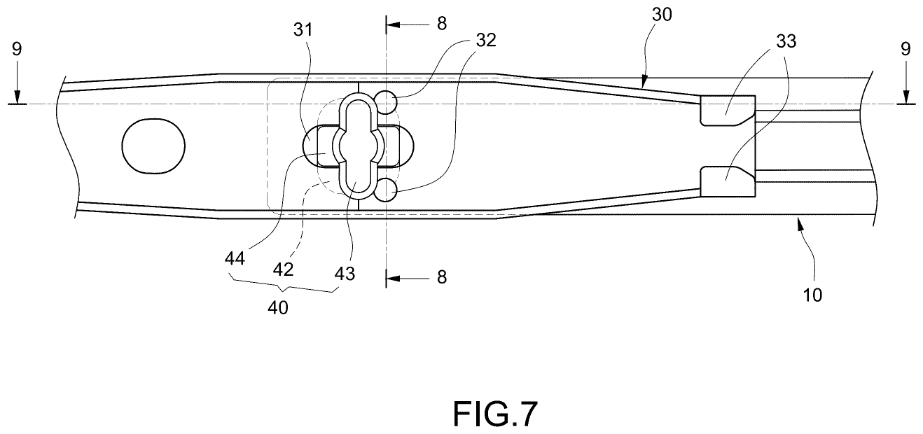

As shown in FIG. 6, the assembling process puts the blocking portion 43 of the fastener 40 to pass through the second through slot 31 of the wing strip 30 such that the main body 41 of the fastener 40 penetrates the first through slot 12 of the medium frame 10 and the second through slot 31 of the wing strip 30 at the same time, then the assembling process rotates the medium frame 10 to change it from a state intersecting to the wing strip 30 to another state parallel to the wing strip 30 to lock the wiper skeleton assembly. It is worth mentioning that since the locking portion 44 of the fastener 40 is embedded in the first through slots 12 of the medium frame 10, the medium frame 10 would drive the fastener 40 to rotate relative to the wing strip 30 when rotating. As a result, the blocking portion 43 of the fastener 40 changes from a state of intersecting to the wing strip 30 to a state of parallel to the wing strip 30, so as to lock the fastener 40 to make the upper cover 42 and the blocking portion 43 to block respectively to the top surface of the medium frame 10 and a bottom surface of the wing strip 30, as shown in FIG. 7

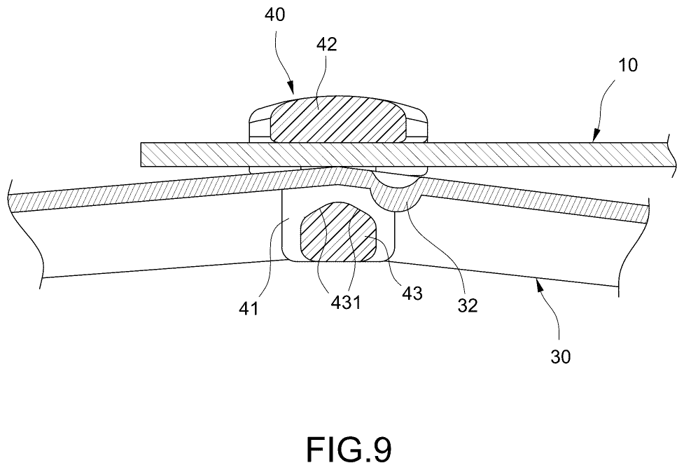

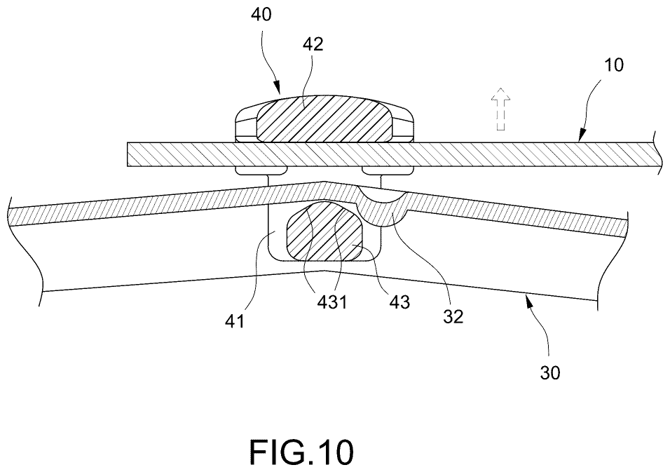

More particularly, since the locking portion 44 of the fastener 40 is embedded in the first through slots 12 of the medium frame 10, when the wiper skeleton assembly of the present disclosure is to be unlocked, the fastener 40 needs to be moved upward relative to the medium frame 10 and the wing strip 30 so that the locking portion 44 of the fastener 40 is upwardly separated from the first through slots 12 of the medium frame 10, and then the fastener 40 is rotated to make the blocking portion 43 change from a state of intersecting to the first through slots 12 and the second through slot 31 to a state of parallel to the first through slots 12 and the second through slot 31 such that the fastener 40 could be removed from the medium frame 10 and the wing strip 30. Please refer FIG. 9 and FIG. 10. A guiding-cone surface 431 is formed on a top of the blocking portion 43 (that is a side surface facing to the upper cover 42) to facilitate an unlocking of the wiper skeleton assembly. That is when a user is rotating the fastener 40 with an external force, the top of the blocking portion 43 can easily release through the guiding-cone surface 431 from stopping of the stopping block 32 by pushing of the external force.

In addition, please refer FIGS. 7, 8, 9, and 10. When the wiper skeleton assembly of the present disclosure is locked, the stopping blocks 32 are located on the two opposite sides of the second through slots 31 and located on the same side with the blocking portion 43. Thus, when the wiper skeleton assembly of the present disclosure is influenced by a shock or impact to make the medium frame 10 and the fastener 40 to move upward (as shown in FIG. 10) and rotate clockwise or counterclockwise relative to the wing strip 30, the blocking portion 43 of the fastener 40 could not easily rotate because of blocking by the stopping block 32, so that it can prevent the fasteners 40 loosened from the medium frame 10 and the wing strips 30 due to vibration, collision, or prolonged use to ensure the structure of the wiper skeleton assembly to be stable.

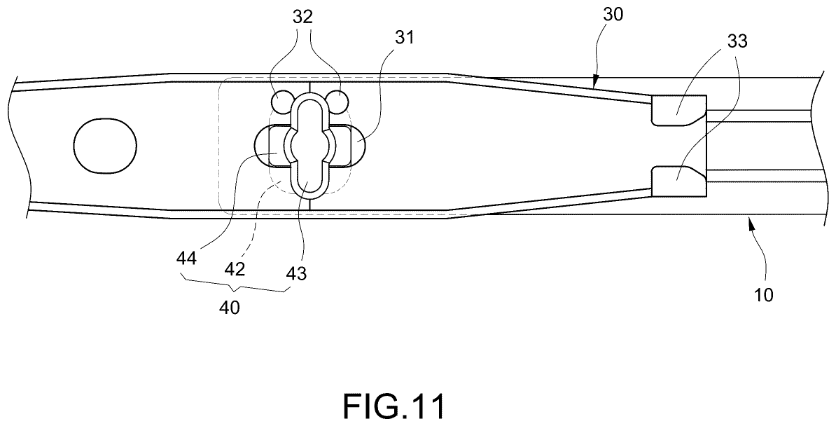

Please refer FIG. 11, which is the second embodiment of the wiper skeleton assembly of the present disclosure, the main difference between the second embodiment and the first embodiment mentioned above is the arranged position of the stopping block 32 of each of the wing strips 30. In detail, in the second embodiment, a number of the stopping block 32 of each of the wing strips 30 is still two, yet the stopping blocks 32 are arranged on a same side of the second through slot 31 and located on two opposite sides of the corresponded blocking portion 43. Therefore, though the arranged position of the stopping block 32 is different, the stopping blocks 32 still can block the blocking portion 43 when the blocking portion 43 is rotating clockwise or counterclockwise, so that it can prevent the fasteners 40 loosened from the medium frame 10 and the wing strips 30 due to vibration, collision, or prolonged use.

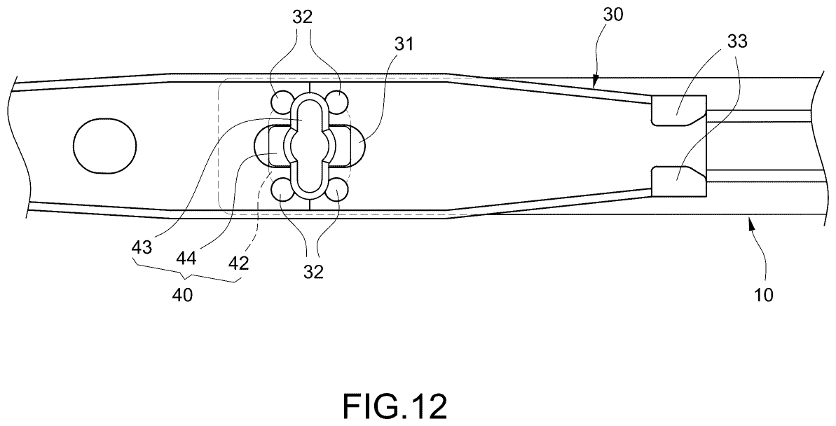

Please refer FIG. 12, which is the third embodiment of the wiper skeleton assembly of the present disclosure, the main difference between the third embodiment and the first embodiment mentioned above is a number of the stopping block 32 of each of the wing strips 30 in the third embodiment is four. In detail, in the third embodiment, two of the stopping blocks 32 are respectively arranged on two opposite sides of the second through slot 31, and the other two stopping blocks 32 are respectively located on two opposite sides of the corresponded blocking portion 43. Thus, compared with the first embodiment mentioned above or the second embodiment mentioned above, the third embodiment can more firmly block the blocking portion 43 of the fastener 40 to effectively ensure the structure of the wiper skeleton assembly to be stable.

Details are provided as follows. Please refer again to FIG. 1. When the wiper skeleton assembly of the present disclosure is installed on the wiper, the four wing strips 30 connected by the two medium frames 10 clamp a wiper blade 60 together, and a buckle socket 70 is connected to the top of the main frame 20. In detail, a claw (see in FIG. 2) is formed on two sides of each of the wing strips 30 to firmly clamp a top of the wiper blade 60. The buckle socket 70 is used for connecting to a wiper handle (not shown in figures) of a vehicle to drive the wiper skeleton assembly and the wiper blade 60.

Through arranging at least one stopping block 32 on a side of each of the wing strips 30 away from the medium frame 10 and adjacent to the second through slots 31, the stopping blocks 32 can respectively block the sides of the blocking portions 43 when the wiper skeleton assembly is locked, so that it can prevent the fasteners 40 loosened from the medium frame 10 and the wing strips 30 due to vibration, collision, or prolonged use to ensure a structure of the wiper skeleton assembly to be stable.

It shall be understood that the present disclosure may have other types of embodiments, and a person with ordinary skills in the art of the technical field of the present disclosure may make various changes and modifications corresponding to the present disclosure without deviating the principle and substance of the present disclosure; however, such corresponding changes and modification shall be considered to be within the claimed scope of the present disclosure.

What is claimed is:

1. A wiper skeleton assembly, comprising:
a medium frame, comprising a pivot portion and defining a pair of first though slots, the pivot portion located between the first though slots, the first though slots respectively arranged on two ends of the medium frame;
a main frame, one end of the main frame pivoted to the pivot portion;
a pair of wing strips, respectively configured to corresponding to each of the first though slots, each of the wing strips defining a second though slot and comprising a stopping block, the stopping block in each of the wing strips arranged on a side of the wing strip away from the medium frame and adjacent to the second through slot; and
a pair of fasteners, respectively configured to corresponding to each of the wing strips, each of the fasteners comprising a main body, an upper cover, and a blocking portion, the upper cover and the blocking portion respectively connected to two ends of the main body in each of the fasteners;
wherein when the wiper skeleton assembly is locked, the main body of each of the fasteners penetrates the second through slot of the corresponded wing strip and the corresponded first through slot of the wing strip, the blocking portion and the upper cover in each of the fasteners respectively are abutted to opposite sides of the corresponded wing strip and the medium frame, each of the stopping blocks being configured to block a side of each of the blocking portions.

2. The wiper skeleton assembly according to claim 1, wherein each of the fasteners further comprises a locking portion extended from the main body and located between the upper cover and the blocking portion, each of the locking portions is accommodated in each of the corresponded first through slots when the wiper skeleton assembly is locked.

3. The wiper skeleton assembly according to claim 2, wherein in each of the fasteners, the locking portion and the blocking portion are arranged on the main body in an intersecting and staggered manner.

4. The wiper skeleton assembly according to claim 2, wherein in each of the fasteners, a shape of the locking portion is corresponding to a shape of the first through slot.

5. The wiper skeleton assembly according to claim 1, wherein in each of the wing strips, a number of the stopping block is two, the stopping blocks are respectively arranged on two opposite sides of the second through slot and located on a same side with the corresponded blocking portion.

6. The wiper skeleton assembly according to claim 1, wherein in each of the wing strips, a number of the stopping block is two, the stopping blocks are arranged on a same side of the second through slot and located two opposite sides of the corresponded blocking portion.

7. The wiper skeleton assembly according to claim 1, wherein in each of the wing strips, a number of the stopping block is four, two of the stopping blocks are respectively arranged on two opposite sides of the second through slot, the other two stopping blocks are respectively located on two opposite sides of the corresponded blocking portion.

8. The wiper skeleton assembly according to claim 1, wherein a shape of the blocking portion is corresponding to a shape of the first through slot and the second through slot.

9. The wiper skeleton assembly according to claim 1, further comprising a pivot shaft, the main frame defines a pair of through holes, the pivot portion defines a pair of pivot holes, the pivot shaft penetrates the through holes and the pivot holes such that the main frame is pivoted on the pivot portion.

10. The wiper skeleton assembly according to claim 1, wherein a number of the medium frame is two, a number of the wing strip is two pairs, a number of the fastener is two pairs, two ends of the main frame is pivoted to the pivot portions, the medium frames, the wing strips, and the fasteners are symmetrically arranged on the two ends of the main frame.
